(19) United States
(12) Patent Application Publication
(10) Pub. No.: US 2008/0003852 A1
(43) Pub. Date: Jan. 3, 2008

(54) Spring Loaded Electrical Terminal

(76) Inventor: Xiang Xu, Kuns Han City Jiangso (CN)

Correspondence Address: Stephen Z. Weiss;Molex Incorporated, 2222 Wellington Ct., Lisle, IL, 60532, US

(21) Appl. No.: 10/579,488

(22) PCT Filed: Nov. 19, 2004
(86) PCT No.: PCT/US04/39091

§ 371 Date: Feb. 8, 2007

(30) Foreign Application Priority Data
Nov. 20, 2003 (CN) 2003 2010066888

(51) Int. Cl. H01R 13/24

(52) U.S. Cl. 439/131

(57) ABSTRACT

An electrical terminal (30) includes first (32) and second (34) contact members having outer pressure contacting end portions (32a, 34a) for pressure engaging a pair of electrical devices and enlarged inner end portions (32b, 34b). A sleeve (36) includes a through hole (44) for slidably receiving the inner end portions of the contact members. The through hole has opposite open ends (46, 48) through which the pressure contacting end portions of the contact members project for engaging the spaced electrical devices. A biasing member (38) is disposed in the through hole to resiliently bias the contact members in opposite directions. The biasing member is in a relaxed condition when the pressure contacting end portions of the contact members are out of pressure engagement with the electrical devices. Thereby, one of the contact members can be retracted substantially into the through hole to thereby reduce the distance between distal ends of the pressure contacting end portions of the contact members.

### FIELD OF THE INVENTION

This invention generally relates to the art of electrical connectors and, particularly, to a pressure-contacting electrical terminal for electrically coupling a pair of electrical devices.

### BACKGROUND OF THE INVENTION

As is known in the art, pressure contacting electrical terminals are used to form a conductive circuit between two electrical devices by pressure engagement therebetween, such as establishing a connection between a mobile phone and an antenna. During assembly, one end of the terminal first is pressure engaged with a first electrical device, and an opposite end of the terminal then is pressure engaged with the second electrical device, thereby establishing an electrical connection between the two electrical devices.

For instance, FIG. 1 shows a prior art electrical terminal, generally designated 10, of the character described above. The terminal includes a sleeve or housing 12 having an inner conductive liner 14 forming a through hole 16 through the housing. The through hole has opposite open ends 18. A pair of contact members 20 have outer pressure contacting end portions 20a and enlarged inner end portions 20b. The inner end portions are reciprocally mounted within through hole 16, while outer end portions 20a project through openings 18 and outwardly of the housing. A coil spring 22 is disposed within through hole 16 and has opposite ends in engagement with the enlarged inner end portions 20b of contact members 20 to bias the contact members in opposite directions. It can be seen that the outer pressure contacting end portions 28a of contact members 20 have identical lengths.

It has been found that in some applications, the restricted or narrow distance between the two electrical devices which are to be electrically connected by terminal 10 makes it difficult to assemble terminal 10 between the electrical devices, because of the distances which the two contact members 20 project from opposite ends of housing 12. In other words, the total distance between the distal ends of outer end portions 20a of the contact members is excessive in comparison to the distance between the two, spaced electrical devices, and this makes it difficult to assemble the terminal between the devices. The present invention is directed to solving these problems and providing improvements in pressure-contacting electrical terminals of the character described.

### SUMMARY OF THE INVENTION

An object, therefore, of the invention is to provide a new and improved electrical terminal of the character described.

In the exemplary embodiment of the invention, the electrical terminal includes first and second contact members having outer pressure contacting end portions for pressure engaging a pair of spaced electrical devices and enlarged inner end portions. A sleeve includes a through hole for slidably receiving the inner end portions of the contact members. The through hole has opposite open ends through which the pressure contacting end portions of the contact members project for engaging the spaced electrical devices. A biasing member is disposed in the through hole to resiliently bias the contact members in opposite directions. The biasing member is in a relaxed condition when the pressure contacting end portions of the contact members are out of pressure engagement with the electrical devices. Thereby, one of the contact members can be retracted substantially into the through hole to thereby reduce the distance between distal ends of the pressure contacting end portions of the contact members.

According to an aspect of the invention, restricted stops are provided at the opposite open ends of the through hole for abutting the enlarged inner end portions of the contact members to define outer limit positions of the pressure contacting end portions of the contact members. As disclosed herein, the restricted stops comprise inwardly turned flanges of the sleeve at the opposite open ends thereof.

Continuing further, the sleeve includes an inner tube surrounded by an outer tube. The enlarged inner end portions of the contact members are reciprocally slidably mounted in opposite ends of the inner tube. The outer tube may be fabricated of dielectrical material, and the inner tube is fabricated of conductive material. The restricted stops are formed by inwardly turned flanges of the inner and outer tubes at the opposite open ends of the sleeve. Opposite ends of the inner tube abut against the flanges.

As disclosed herein, the biasing member comprises a coil spring having opposite ends engageable with the enlarged inner end portions of the contact members. The outer pressure contacting end portion of one of the contact members is shorter than the outer contacting end portion of the other contact member.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a longitudinal or axial section through an electrical terminal according to the prior art and as described in the Background, above;

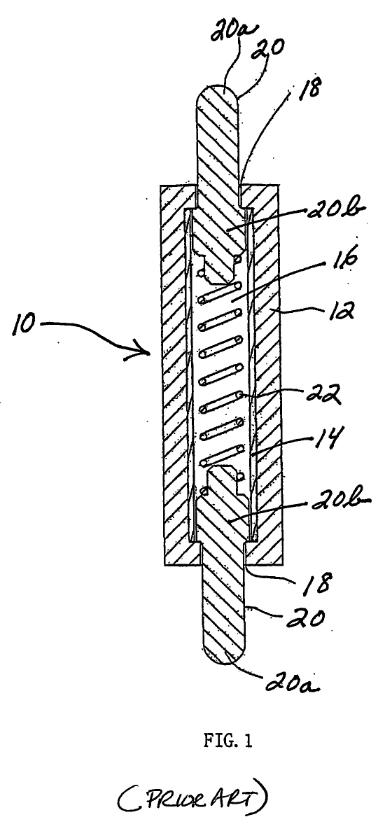

FIG. 2 is an exploded perspective view of an electrical terminal according to the invention;

FIG. 3 is a perspective view of the electrical terminal of FIG. 2;

FIG. 4 is a longitudinal or axial section through the terminal;

FIG. 5 is a perspective view of the terminal mounted within an encapsulating housing;

FIG. 6 is a longitudinal or axial section of the assembly of FIG. 5, located between a pair of electrical devices, and with the coil spring of the terminal in a relaxed or non-compressed condition; and

FIG. 7 is a view similar to that of FIG. 6, with the electrical devices spaced closer together in pressure engagement with the contact members of the terminal, compressing the coil spring.

### DETAILED DESCRIPTION OF THE PREFERRED EMBODIMENT

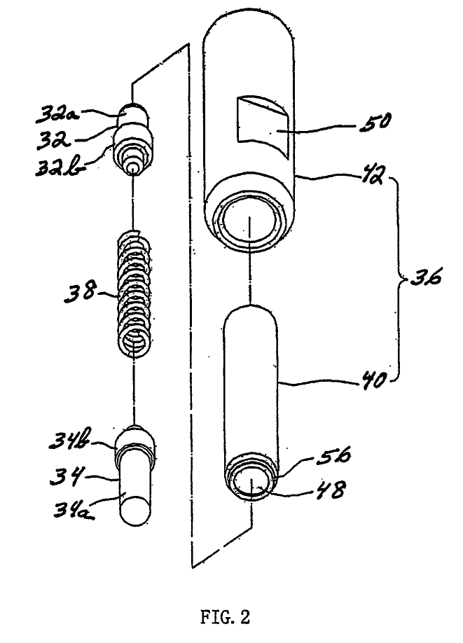

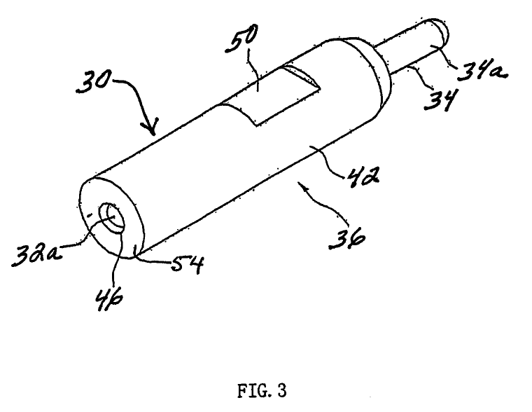

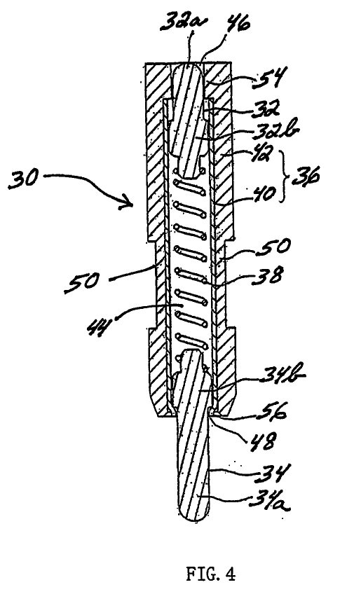

Referring to the drawings in greater detail, and first to FIGS. 2-4, the invention is embodied in an electrical terminal, generally designated 30, which includes a first contact member 32 and a second contact member 34 reciprocally mounted within a sleeve 36. A coil spring 38 is disposed within the sleeve for resiliently biasing the contact members in opposite directions. However, according to the invention, when the terminal is out of engagement with a pair of electrical devices (described hereinafter), coil spring 38 is in a relaxed or non-compressed condition as shown in FIG. 4.

More particularly, first contact member 32 of terminal 30 includes an outer pressure contacting end portion 32a for engaging a first electrical device as described hereinafter. The first contact member includes an enlarged inner end portion 32b.

Second contact member 34 of terminal 30 includes an outer pressure contacting end portion 34a for pressure engaging a second electrical device as described hereinafter. The second contact member includes an enlarged inner end portion 34b. The first and second contact members are fabricated of conductive material such as metal.

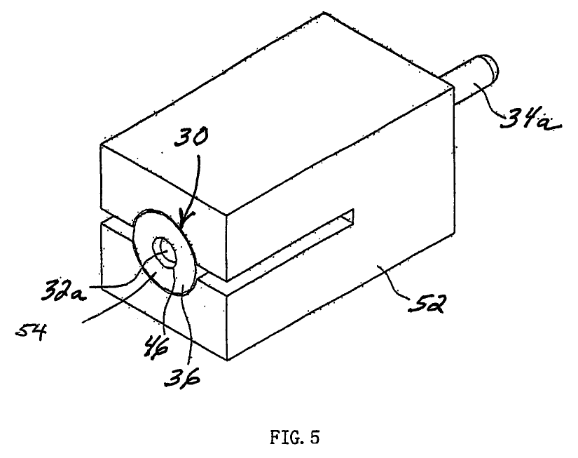

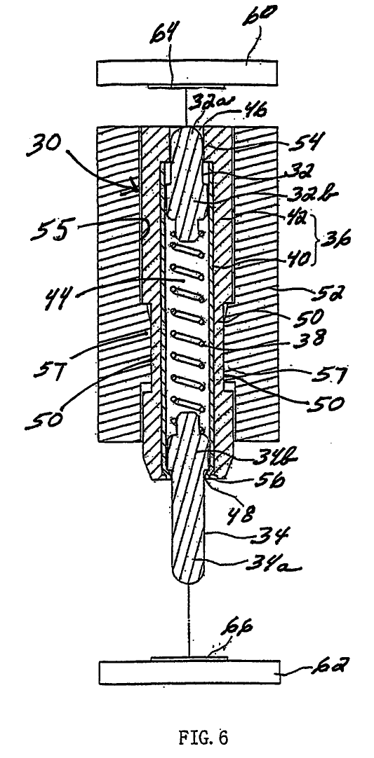

Sleeve 36 of terminal 30 includes an inner tube 40 surrounded by an outer tube 42. The inner tube is fabricated of conductive metal material in an open-ended cylindrical configuration. Outer tube 42 may be fabricated of dielectric material. The inner tube defines a through hole 44 for slidably receiving the inner end portions 32b and 34b of first and second contact members 32 and 34, respectively. The open ends of the through hole communicate with first and second open ends 46 and 48, respectively, of the sleeve. A pair of diametrically disposed positioning recessed 50 are formed in the outer surface of outer tube 42 of the sleeve for locating the terminal within an encapsulating housing 52 shown in FIGS. 5 and 6 and described hereinafter.

Generally, restricted stops are provided at the first and second open ends of the through hole for abutting the enlarged inner ends 32b and 34b of contact members 32 and 34, respectively, to define outer limit positions of the pressure contacting end portions 32a and 34a of the contact members. More particularly, a first restricted stop at first open end 46 of the sleeve is formed by an inwardly turned flange 54 of outer sleeve 42. A second restricted stop at second open end 48 of the sleeve is formed by an inwardly turned flange 56 of inner tube 40. Flanges 54 and 56 abut against the enlarged inner end portions 32b and 34b, respectively, of first and second contact members 32 and 34, respectively. These stop flanges define the outer limit positions of the pressure contacting end portions 32a and 34a of the contact members.

According to the invention, coil spring 38 is located within through hole 44 of sleeve 36 in a relaxed or non-compressed condition when terminal 30 is not in pressure engagement with any electrical devices. This can be seen in FIG. 4 where the outer pressure contacting end portion 32a of first contact member 32 is retracted completely within open end 46 of the sleeve. In other words, the first contact member is retracted within the sleeve without any pressure engaging forces from any external devices. It also can be seen in FIG. 4 that the outer pressure contacting end portion 32a of first contact member 32 is shorter than the outer pressure contacting end portion 34a of second contact member 34. By installing the coil spring in a relaxed or non-compressed condition, and with the first contact member retracted within the sleeve, the distance between the extreme distal ends of outer pressure contacting end portions 32a and 34a of the contact members is reduced. This allows terminal 30 to be more easily installed between a pair of spaced electrical devices which have limited spacing therebetween.

FIGS. 5 and 6 show electrical terminal 30 mounted within a passage or cavity 55 of encapsulating housing 52. The housing has positioning ribs 57 (FIG. 6) which snap into positioning recesses 50 in the outer surface of outer tube 42 of sleeve 36 of the terminal.

FIG. 6 shows electrical terminal 30, encapsulated within housing 52, and disposed between first and second electrical devices 60 and 62, respectively, which have fixed contacts 64 and 66, respectively. Although the spacing between the electrical devices may be somewhat exaggerated in FIG. 6, it clearly can be seen that by retracting first contact member 32 within sleeve 36, the overall longitudinal dimension of electrical terminal 30 is considerably reduced. This allows for more space to manipulate the terminal between the electrical devices or to manipulate the electrical devices into position at opposite ends of the terminal. This is important in installing the terminal in very confined applications involving ever-increasing miniaturization of electrical components or systems.

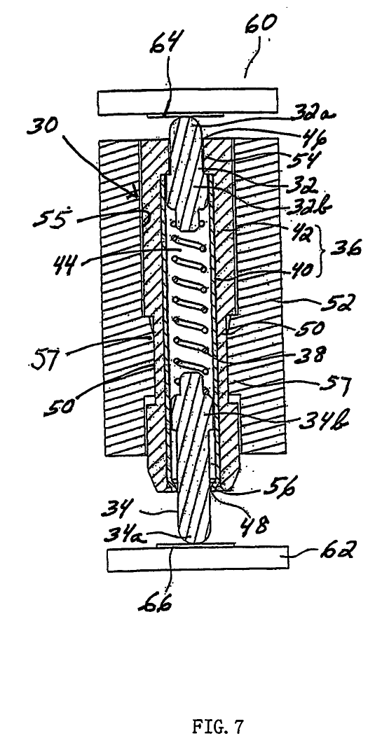

When electrical devices 60 and 62 are brought into pressure engagement with the outer pressure contacting end portions 32a and 32b of first and second contact members 32 and 34, respectively, as shown in FIG. 7, contact member 34 is pushed inwardly into through hole 44, compressing coil spring 38. This pushes contact member 32 out of the opposite end of the terminal. Therefore, the coil spring resiliently biases the contact members in opposite directions and pressure engages outer pressure contacting end portions 32a and 32b of the contact members against fixed contacts 64 and 66, respectively, of electrical devices 60 and 62, respectively.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical terminal (30), comprising:
a first contact member (32) having an outer pressure contacting end portion (32a) for pressure engaging a first electrical device (60) and an enlarged inner end portion (32b);
a second contact member (34) having an outer pressure contacting end portion (34a) for pressure engaging a second electrical device (62) and an enlarged inner end portion (34b);
a sleeve (36) including
a through hole (44) for slidably receiving the inner end portions of the first and second contact members,
said through hole having a first open end (46) through which the pressure contacting end portion of the first contact member projects and a second open end (48) through which the pressure contacting end portion of the second contact member projects, and
restricted stop means (54,56) at the first and second open ends of the through hole for abutting the enlarged inner end portions of the contact members to define outer limit positions of the pressure contacting end portions of the contact members; and
a biasing member (38) in the through hole of the housing to resiliently bias the contact members in opposite directions, the biasing member being in a relaxed condition when the pressure contacting end portions of the contact members are out of pressure engagement with the electrical devices, whereby one of the contact members (32) can be retracted substantially into the through hole to thereby reduce the distance between distal ends of the pressure contacting end portions (32a,34a) of the contact members (32,34).

2. The electrical terminal of claim 1 wherein said restricted stops comprise inwardly turned flanges (54,56) of the sleeve at said first and second open ends (46,48) thereof.

3. The electrical terminal of claim 1 wherein said sleeve (36) includes an inner tube (40) surrounded by an outer tube (42), with the contact members (32,34) being reciprocally slidably mounted in opposite ends of the inner tube.

4. The electrical terminal of claim 3 wherein said inner tube (40) is fabricated of conductive material and said outer tube (42) is fabricated of dielectric material.

5. The electrical terminal of claim 3 wherein said restricted stop means at one open end (46) of the sleeve is formed by an inwardly turned flange (54) of the outer tube (42).

6. The electrical terminal of claim 3 wherein said restricted stop means at one open end (48) of the sleeve is formed by an inwardly turned flange (56) of the inner tube (40).

7. The electrical terminal of claim 6 wherein said restricted stop means at an opposite open end (46) of the sleeve is formed by an inwardly turned flange (54) of the outer tube (42).

8. The electrical terminal of claim 7 wherein opposite ends of the inner tube (40) abut against said flanges (54,56).

9. The electrical terminal of claim 3 wherein the outer tube (42) of said sleeve (36) includes a positioning recess (50) in an outer surface thereof for positioning the electrical terminal (30) in an appropriate housing (52).

10. The electrical terminal of claim 1 wherein said biasing member comprises a coil spring (38) having opposite ends engageable with the enlarged inner end portions (32b,34b) of the contact members (32,34).

11. The electrical terminal of claim 1 wherein the outer pressure contacting end portion (32a) of one of said contact members (32) is shorter than the outer pressure contacting end portion (34a) of the other contact member (34).
